(19) United States
(12) Patent Application Publication
(10) Pub. No.: US 2016/0055121 A1
(43) Pub. Date: Feb. 25, 2016

(54) NODE-BASED SEQUENTIAL IMPLICIT ENUMERATION METHOD AND SYSTEM THEREOF

(71) Applicant: National Tsing Hua University, Hsinchu City (TW)

(72) Inventor: Wei-Chang Yeh, Hsinchu City (TW)

(21) Appl. No.: 14/558,985

(22) Filed: Dec. 3, 2014

(30) Foreign Application Priority Data
Aug. 20, 2014 (TW) 103128582

(51) Int. Cl. G06F 17/10

(52) U.S. Cl. CPC G06F 17/10

(57) ABSTRACT

A node-based sequential implicit enumeration method is provided, including: setting a multistate flow network, building an integer programming model of the multistate flow network, and finding a solution set of level number 1 and a number of elements in the solution set from the integer programming model according to the flow conservation law, then using one of the elements to sequentially find a solution set of a next level number and a number of elements in the solution set until the level number being N−1 to complete a new complete solution set, afterward, sequentially returning to the preceding level numbers to determine whether there are other elements in the solution set, and if so, repeating above steps to produce another new complete solution set until the solution sets of all level numbers have been checked, and determining the final complete solution set as a set of the minimal path satisfying the required flow, so as to find all d-MP in the integer programming model of the multistate flow network efficiently.

### BACKGROUND DISCLOSURE

1. Technical Field Disclosure

The present disclosure relates to implicit enumeration methods for finding a minimal path, and, more particularly, to a node-based sequential implicit enumeration method and system for finding all minimal paths with capacity level d in a multistate flow network.

2. Description of Related Art

The traditional multistate flow network (MFN) is a common network structure, in which each node satisfies the flow conservation law and each arc has multiple independent, discrete, limited and random values. Recently, MFNs have broadly modeled many real-world systems, such as computer networks, supply chain systems and electrical power or transportation networks. Hence, MFNs play an important role in current application and research and have thus attracted much attention from researchers.

The MFN has been extensively adapted to model many real-world multistate systems, which satisfy the flow conservation law, e.g., energy distribution networks, fluid distribution networks, and supply chain networks. Reliability is the key aspect to measure the performance of an MFN. However, currently the general method for solving MFN reliability problems limits the discussion to a two-terminal reliability analysis. The MFN (two-terminal) reliability refers to the probability that the MFN functions such that the minimum required amount of flow can be transmitted from a source node to a sink node successfully. The minimal path with capacity level d (d-MP) is a special vector such that the flow from the source node to the sink node is equal to d, and each arc is saturated in the MFN constructed by this vector. Searching for all d-MPs is the most important methodology in determining the MFN reliability.

The graph method based on a path/cut set is a common means for solving MFN reliability problems. In the path-based method, the goal is to search for each possible vector (called d-MPs here), and only real d-MPs can be used in the sum of a disjoint product method or the inclusion-exclusion method (two major methods) to calculate the final reliability in the path-based algorithms. Hence, all path-based algorithms are focused on finding d-MPs, comprising three major steps: (1) searching all d-MP candidates; (2) verifying each d-MP candidate to see whether it is a real d-MP; and (3) calculating MFN reliability in terms of the true d-MPs. Among these three steps, the main obstacle for solving the MFN reliability is step (1). Until now, the implicit enumeration method (IEM) has been the only way to search for d-MPs. The IEM, which grows exponentially with the number of nodes, is still the main tool for solving the integer programming model (F-IP). The IEM is a trial-and-error method, and most of these steps in IEM appear to be superfluous, which impacts the whole processing efficiency.

Therefore, as it is known that the most difficult part of solving the reliability problem of the MFNs is to find all d-MP candidates, which especially reduces the subsequent determinations of solution sets of unsuitable d-MPs, how to find a simple and efficient method to solve correctly the F-IP becomes the objective being pursued by persons skilled in the art.

### SUMMARY OF THE DISCLOSURE

Given abovementioned defects of the prior art, the present invention provides a method for finding d-MP candidates by an integer programming model. With the sequential implicit enumeration method, a correct integer programming model can be simply and efficiently obtained.

In order to achieve abovementioned and other objectives, the present invention provides a node-based sequential implicit enumeration system, comprising: a presetting module, a building module and a computing module including a solution set unit, a recurring unit and a unifying unit. The presetting module sets a multistate flow network including a number of nodes and required flow, wherein the number of nodes is N. The building module builds an integer programming model of the multistate flow network, so as to set a complete solution set of the integer programming model as an empty set and set a level number as 1 in advance. The computing module obtains a complete solution set of a minimal path satisfying the required flow, where the solution set unit finds solution sets of each node in the integer programming model according to a flow conservation rule and excludes unsuitable ones, so as to find a number of elements in each solution set; the recurring unit adds 1 to the level number when the level number is determined being less than N−1, so as to use one of the elements in the solution set to sequentially find a solution set of a next level number and a number of elements in the solution set of the next level number through the solution set unit until the level number is equal to N−1; and the unifying unit unifies the complete solution set and the solution set of level number N−1, so as to generate a new complete solution set. After the solution set of level number N−1 is obtained, when the level number is larger than 1, the recurring unit subtracts 1 from the level number to determine whether other elements exist in the solution set of the level number, and if so, repeating procedures of the solution set unit, the recurring unit and the unifying unit to produce another new complete solution set, otherwise 1 is continuously subtracted from the level number until the level number is 1, such that a set of minimal path satisfying the required flow is obtained as a final complete solution set.

In an embodiment, the solution set unit excludes a solution set causing a flow between a current node and a next node being larger than a maximal capacity between the current node and the next node from the solution sets of each of the nodes.

In another embodiment, the solution set unit excludes one consisting of nodes forming a loop and having a nonzero flow in the integer programming model from each of the solution sets.

The present invention further provides a node-based sequential implicit enumeration method, comprising the steps of: (a) setting a multistate flow network including N nodes and required flow; (b) building an integer programming model of the multistate flow network, so as to set a complete solution set of the integer programming model as an empty set and set a level number as 1 in advance; (c) finding solution sets of the level number 1 in the integer programming model according to flow conservation and excluding unsuitable ones, so as to find a number of elements in the solution set, adding 1 to the level number when the level number is determined being less than N−1, so as to use one of the elements in the solution set to sequentially find a solution set of a next level number and a number of elements in the solution set of the next level number until the level number is equal to N−1; (d) unifying the complete solution set and the solution set of level number N−1, so as to generate a new complete solution set; and (e) subtracting 1 from the level number to determine whether other elements exist in the solution set of the level number when the level number is larger than 1, and if so, repeating steps (c) and (d) to produce another new complete solution set, otherwise 1 is continuously subtracted from the level number until the level number is 1, such that a final complete solution set thus-obtained is a set of minimal path satisfying the required flow.

In an embodiment, the step of determining whether other elements exist in the solution set of the level number further comprises: setting a count with an initial value 1 when the number of elements of the solution set is found, so as to determine that the solution set has other elements when the number of elements of the solution set is larger than the count.

According to the prior art, since a path-based algorithm is often used in measuring the reliability of the multistate flow network and all path-based algorithm have to find all d-MPs, the implicit enumeration method (IEM) and the IEM is a trial-and-error method, such that the path-based algorithm is troublesome and time-consuming. By contrast, the present invention provides a node-based sequential implicit enumeration method and system, which reduce the defect of low efficiency, caused by that the conventional path-based algorithms have to find all possible d-MPs, according to the recursion process of the node equation. Thus, the integer programming model of the multistate flow network can be easily and efficiently obtained.

### BRIEF DESCRIPTION OF DRAWINGS

The present invention can be more fully understood by reading the following detailed description of the exemplary embodiments, with reference made to the accompanying drawings, wherein:

FIG. 1 is a system structure view of a node-based sequential implicit enumeration system according to the present invention;

FIGS. 2A to 2C are exemplary scheme views of maximal capacity, state vector and loop of an integer programming model according to the present invention; and

FIG. 3 is a flow chart of a node-based sequential implicit enumeration method according to the present invention.

### DETAILED DESCRIPTION OF THE DISCLOSURE

In the following, specific embodiments are provided to illustrate the detailed description of the present invention. Those skilled in the art can easily conceive the other advantages and effects of the present invention, based on the disclosure of the specification. The present invention can also be carried out or applied by other different embodiments.

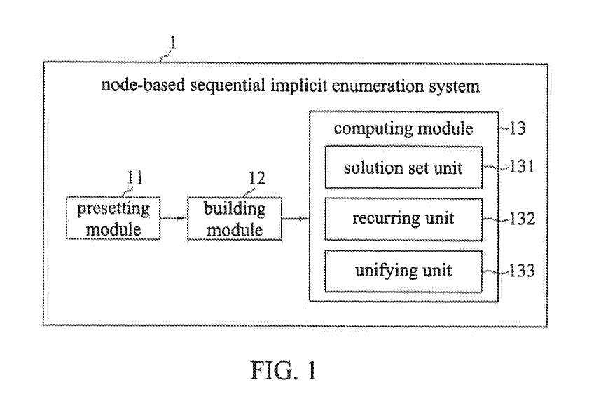

As shown in FIG. 1, a system structure view of a node-based sequential implicit enumeration system 1 according to the present invention is provided. The node-based sequential implicit enumeration system 1 comprises a presetting module 11, a building module 12, and a computing module 13 including a solution set unit 131, a recurring unit 132 and a unifying unit 133, so as to rapidly find a complete and correct solution set of minimal path with capacity level d (d-MP) candidates.

The presetting module 11 sets a multistate flow network (MFN) including a number of nodes and required flow, wherein the number of nodes is N. The required flow refers to flow entering to an initial node or exiting from an final node. According to the flow conservation law, except the initial node and the final node, the entering flow and exiting flow of other nodes are equal, such that the flow exiting from the initial node is equal to the flow entering to the final node.

The building module 12 builds an integer programming model of the MFN, so as to set a complete solution set of the integer programming model as an empty set and set a level number as 1 in advance. After the number of nodes and required flow are set, an integer programming model satisfying above setting can be built according to the MFN, and the complete solution set (i.e., a final solution set) is set as an empty set for performing a subsequent calculation of the solution set. Moreover, the level number being used in the calculation is set as 1 in advance.

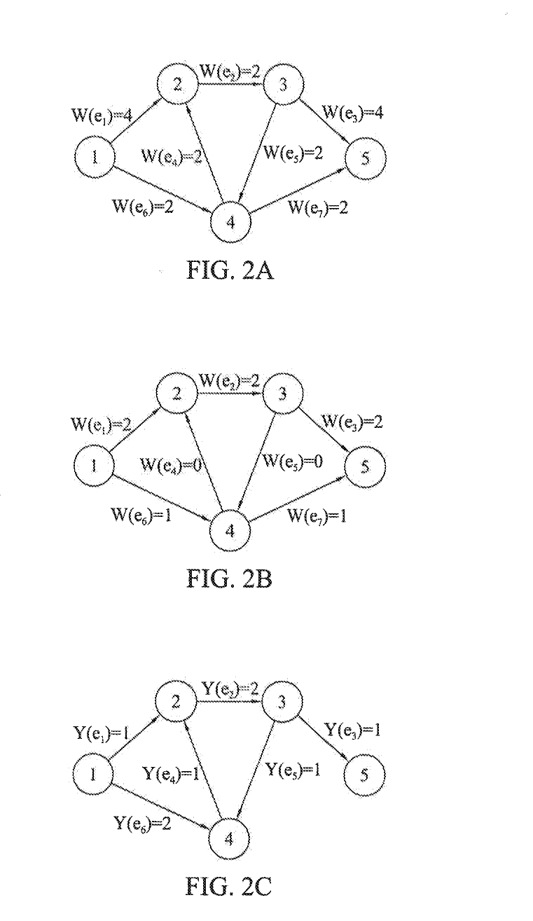

As shown in FIG. 2A, an example of the integer programming model is illustrated, where five nodes are included, and node 1 is an initial node and node 5 is a final node. W(e₁) represents a maximal capacity of the first arc and W(e₁)=4, similarly, maximal capacities of the second to seventh arcs refer to W(e₂)=2, W(e₃)=4, W(e₄)=2, W(e₅)=2, W(e₆)=2 and W(e₇)=2.

Next, as shown in FIG. 2B, on the basis of the maximal capacities of each arcs in FIG. 2A, if the required flow is 3, the sum of capacities of arcs W(e₁) and W(e₆) having passed through the node 1 should be 3. Taking the node 4 as an example, the flow from the node 1 to the node 4 passing through the arc W(e₆) is 1, the flow from the node 3 to the node 4 passing through the arc W(e₅) is 0, and the sum of flow entering the node 4 is 1. According to the law conservation law, the flow from the node 4 to the node 2 passing through the arc W(e₄) is 0, and the flow from the node 4 to the node 5 passing through the arc W(e₇) is 1. As such, the sum of the flow exiting from the node 4 is 1. Hence, the flow entering each node equals to the flow exiting therefrom in the integer programming model, and the flow between adjacent two nodes is not larger than the maximal capacity of an arc formed by the two nodes.

The computing module 13 obtains a complete solution set of a minimal path satisfying the required flow. The solution set unit 131 of the computing module 13 finds solution sets of each node in the integer programming model according to the flow conservation law and excludes unsuitable one, so as to find a number of elements in each solution set. For example, as shown in FIG. 2B, after passing through the node 1, there are state vectors X(e₁) and X(e₆), the sum of the two should be 3 (as the required flow is 3), where the combination (0,3) does not satisfy the maximal capacity of W(e₆) and thus is excluded, such that the possible combinations between the state vectors X(e₁) and X(e₆) are (3,0), (2,1) and (1,2). Afterward, unsuitable ones are excluded. In this example, the combination of (3,0) is unsuitable since a solution in the solution set that causes the flow between a current node and a next node being larger than the maximal capacity between the current node and the next node should be excluded. For instance, if the flow of the state vector X(e₁) is 3, the flow will be larger than the maximal capacity 2 of the state vector X(e₂). Once such solution set is built, the flow entering to the final node will be different with the flow exiting from the initial node. Therefore, the feasible combinations are (2,1) and (1,2) only, in other words, the number of elements in the set solution is 2.

The recurring unit 132 adds 1 to the level number when the level number is determined being less than N−1, so as to use one of the elements in the solution set to sequentially find a solution set of a next level number and a number of elements in the solution set of the next level number through the solution set unit 131 until the level number is equal to N−1. The solution set unit 131 first builds a solution set of the first level (i.e., the level number is 1), then the recurring unit 132 performs a calculation of a solution set of the second level, which uses one of the elements of the solution set of the first level to find the solution set and number of elements of the next level of the element until the level number is 1 less than the number of the nodes N.

The unifying unit 133 unifies the complete solution set and the solution set of level number N−1, so as to generate a new complete solution set. The unifying unit 133 unifies the solution set calculated by the solution set unit 131 and the recurring unit 132 with the solution set preset at the beginning, such that a new complete solution set is generated.

Since above process merely finds the solution sets of downward extensions of one of the elements in the solution set of the first level, such as the second level, third level . . . until the n−1^{th} level, in order to find other possible elements in the solution sets of respective levels, it is preferred to go back to previous respective levels to find whether other solution sets are generated during the downward extensions of the elements in the solution sets of respective levels.

Therefore, given the above objective, sequential steps as follows are performed, comprising after the solution set of level number N−1 is obtained, when the level number is larger than 1, the recurring unit 132 subtracts 1 from the level number to determine whether other elements exist in the solution set of the level number, and if so, repeating the procedures of the solution set unit, the recurring unit and the unifying unit to produce another new complete solution set, otherwise 1 is continuously subtracted from the level number until the level number is 1, such that a set of minimal path satisfying the required flow is obtained as a final complete solution set.

In the above description, the solution set unit 131 finds the solution sets of each node of the integer programming model and excludes the unsuitable one comprising the solution in the solution set of each of the nodes of the integer programming model that causes the flow between the current node and the next node being larger than the maximal capacity between these two nodes. For example, as shown in FIGS. 2A and 2B, (3,0) was a possible solution of X(e₁) and X(e₆) at first. However, if the flow of the state vector X(e₁) is 3, the subsequent state vector X(e₂) with the maximal capacity 2 can merely allow the flow of 2 to pass through, which causes the flow entering in the final node 5 to be different with the flow exiting from the initial node 1. In addition, the unsuitable solutions further comprise the one consisting of nodes forming a loop and having nonzero flow in the integer programming model. For example, as shown in FIG. 2B, the flow directions of the nodes 2, 3 and 4 may form a loop, but the state vectors X(e₄) and X(e₅) are zero, thereby not satisfying the loop condition. By contrast, as shown in FIG. 2C, the flow directions of the nodes 2, 3 and 4 may form a loop, and the state vectors X(e₂), X(e₄) and X(e₅) are all nonzero, thereby satisfying the loop condition and thus such solution should be excluded from the solution set.

Furthermore, in order to determine whether other elements are included in the solution set, the recurring unit 132 can set a count with an initial value 1 when the number of elements of the solution set is found, so as to determine that the solution set has other elements when the number of elements of the solution set is larger than the count, and 1 is added to the count until the number of elements of the solution set is equal to the count, which means there is no other element in the solution set.

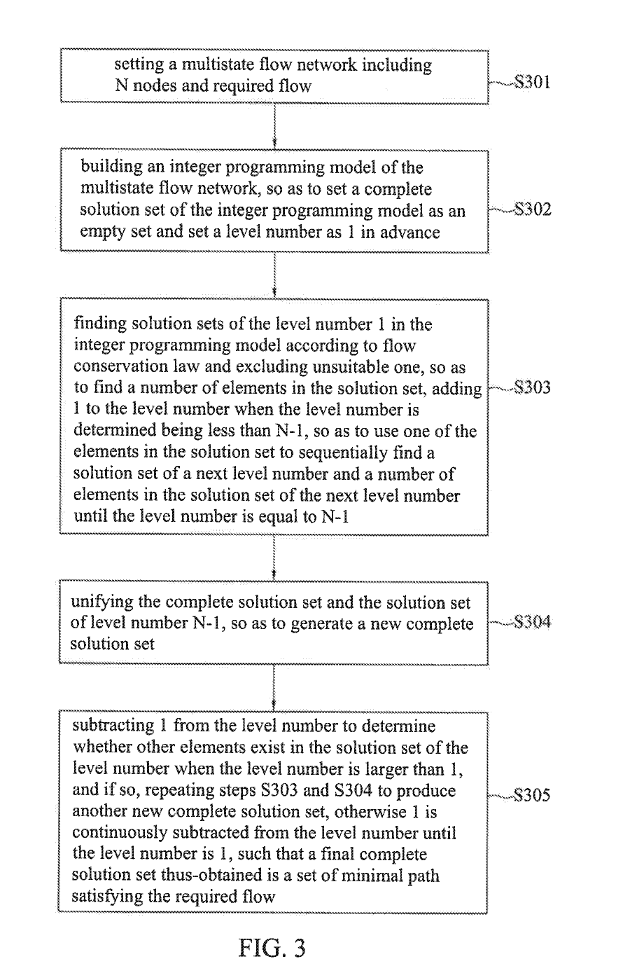

Referring to FIG. 3, a flow chart of a node-based sequential implicit enumeration method according to the present invention is presented.

In step S301, the MFN including N nodes and required flow is set. Specifically, the required flow refers to a flow entering to an initial node or exiting from an final node. Moreover, according to the flow conservation law, except the initial node and the final node, the entering flow and exiting flow of other nodes are equal, such that the flow exiting from the initial node is equal to the flow entering to the final node. Also, a flow entering each node of the integer programming model is equal to a flow exiting therefrom, and a flow between two adjacent nodes is not larger than a maximal capacity of an arc formed by the two adjacent nodes.

In step S302, an integer programming model of the MFN is built, so as to set a complete solution set of the integer programming model as an empty set and set a level number as 1 in advance. In step S302, an integer programming model satisfying the number of nodes and required flow is built according to the MFN. For facilitating a subsequent calculation of the solution set, the complete solution set (i.e., a final solution set) is set as an empty set. Also, the level number is set as 1 in advance.

In step S303, solution sets of the level number 1 in the integer programming model are found according to a flow conservation rule and unsuitable one(s) is excluded, so as to find a number of elements in the solution set, 1 is added to the level number when the level number is determined being less than N−1, so as to use one of the elements in the solution set to sequentially find a solution set of a next level number and a number of elements in the solution set of the next level number until the level number is equal to N−1. Specifically, step S303 intends to find possible solution sets in the integer programming model, in which the initial node (node 1) is the level number 1, and possible solution sets thereof are found and unsuitable one is excluded. Next, one of the solution sets is used to find a suitable solution set in the next level (i.e., level number 2), and so on until the level number is N−1. A number of elements in each solution set of the level numbers is saved for subsequently determining whether other element exists.

Additionally, the abovementioned unsuitable one refers to a solution in each of the solution sets of the integer programming model that causes the flow between a current node and a next node being larger than the maximal capacity between these two nodes, and refers to one consists of nodes forming a loop and having nonzero flow in the integer programming model, as shown in FIGS. 2B and 2C, for example.

In step S304, the complete solution set and the solution set of level number N−1 are unified to generate a new complete solution set. As mentioned above, in order to facilitate to find the complete solution set, the solution set of level number N−1 found in the step S303 and the complete solution set preset as zero are unified, so as to generate a new solution set. In other words, this step unifies a newly found solution set with the original complete solution set, so as to obtain another new complete solution set.

In step S305, when the level number is larger than 1, subtracting 1 from the level number to determine whether other elements exist in the solution set of the level number, and if so, repeating the steps S303 and S304 to produce another new complete solution set, otherwise 1 is continuously subtracted from the level number until the level number is 1, such that a set of minimal path satisfying the required flow is obtained as a final complete solution set. Since the previous steps merely obtain one complete solution set, it is preferred to go sequentially back to previous levels to find whether other solution sets exist in the level, and if so, repeating the steps S303 and S304 until all the solution sets are found.

When the first complete solution set is obtained, the level number should be N−1, such that it is determined that the obtained level number is larger than 1 and thus 1 can be subtracted from the level number. Then, whether other possible solution set exists until the level number is 1 is checked.

In order to determine whether other elements exist in the solution sets of respective level numbers, a count with an initial value 1 can be set when the number of elements of the solution set is found, so as to determine that other element exists when the number of elements of the solution set is larger than the count.

From the foregoing, even in a small network, it is still difficult to find all d-MPs, and it is also difficult to calculate the reliability thereof. Not to mention if the number grows exponentially, the combination of solution sets thereof will be even more complicated. As such, according to the node-based sequential implicit enumeration method, the correct integer programming model can be easily and efficiently obtained through the sequential implicit enumeration manner.

In an embodiment, according to the node-based sequential implicit enumeration method according to the present invention, the whole process can be separated into a pre-step and five following steps, comprising:

Step 0: letting Ω=Ø, i=1, F_{0,0} be an empty vector, and build an integer programming model F-IP based on the flow conservation law.

Step 1: finding a solution set Ωᵢ={F_{i,1}, F_{i,2}, . . . , F_{i,φ(i)}} in F_{i-1, κ(i-1)}-IP, in which the maximal capacity from the initial node to the final node M^{#}(F_{i, κ(i)})=d, and there is no circulation in G(F_{i, κ(i)}), κ(i)=1, 2, . . . , φ(i). In addition, if Ωᵢ=Ø, then steps 2 and 3 can be omitted.

Step 2: if i<n−1, then let κ(i)=1, i=i+1, and go to step 1. Otherwise, continue to step 3.

Step 3: let Ω=Ω∪Ωₙ₋₁, and continue to step 5.

Step 4: if κ(i−1)<φ(i−1), then let κ(i−1)=κ(i−1)+1 and go to step 1. Otherwise, continue to step 5.

Step 5: if i>1, then let i=i−1 and go to step 4. Otherwise, stop the process and Ω is the complete d-MP set.

In the followings, the integer programming model of the MFN of FIG. 2 is taken as an example to specifically describe how to find all minimal paths with capacity level 3 (3-MP).

Performing step 0: let Ω=Ø, i=1, F_{0,0} be an empty vector, and build a flow component between each node in the integer programming model F-IP of FIG. 1, comprising: x₁+x₆=3, x₁+x₄=x₂, x₂=x₃+x₅, x₃+x₇=3, wherein xᵢε{0, 1, . . . , W(eᵢ)}, i=1, 2, 3, 4, 5, 6, 7.

Performing step 1: Ω₁={F_{1,1}=(x₁, x₆)=(2,1), F_{1,2}=(1,2)} is a complete solution set in F_{0,0}-IP. Because x₁+x₆=3, there are two combinations of 2+1=3 and 1+2=3. As such, let φ(1)=2, and go to step 2. It should be noted that even though 3+0=3 or 0+3=3 may also be a possible solution, such solutions cannot be listed in Ω₁ since they would lead to the condition of M^{#}(Fₓ)=0.

Performing step 2: because i=1<n−1=4, then let κ(1)=1, i=i+1=2, and go to step 1.

Performing step 1: Ω₂={F_{2,1}=(x₁, x₂, x₄, x₆)=(2,2,0,1)} is a complete solution set in F_{1,1}-IP, where x₁+x₄=x₂→2+x₄=x₂, let φ(2)=1, and go to step 2.

Performing step 2: because i=2<n−1=4, let κ(2)=1, i=i+1=3, and go to step 1.

Performing step 1: Ω₃={F_{3,1}=(x₁, x₂, x₃, x₄, x₅, x₆)=(2,2,2,0,0,1), F_{3,2}=(2,2,1,0,1,1)} is a complete solution set in F_{2,1}-IP, where x₂=x₃+x₅→2=x₃+x₅, let φ(3)=2, and go to step 2. It should be noted that although F_{X}=(2,2,0,0,2,1) is also a possible solution, such solution cannot be listed in Ω₃ since it would lead to the condition of M^{#}(Fₓ)=0.

Performing step 2: because i=3<n−1=4, let κ(3)=1, i=i+1=4, and go to step 1.

Performing step 1: Ω₄={F_{4,1}=(x₁, x₂, x₃, x₄, x₅, x₆, x₇)=(2,2,2,0,0,1,1)} is a complete solution set in F_{3,1}-IP, where x₃+x₇=3→2+x₇=3, let φ(4)=1, and go to step 2.

Performing step 2: because i=n−1=4, go to step 3.

Performing step 3: let Ω=Ω∪Ω₄={(2,2,2,0,0,1,1)}, and go to step 5.

Performing step 5: because i=4>1, let i=i−1=3, and go to step 4.

Performing step 4: because κ(3)=1<φ(3)=2, let κ(3)=κ(3)+1=2, and go to step 1.

Performing step 1: Ω₄={F_{4,1}=(x₁, x₂, x₃, x₄, x₅, x₆, x₇)=(2,2,1,0,1,1,2)} is a complete solution set in F_{3,2}-IP, where x₃+x₇=3→1+x₇=3, let φ(4)=1, and go to step 2.

Performing step 2: because i=n−1=4, go to step 3.

Performing step 3: let Ω=Ω∪Ω₄={(2,2,2,0,0,1,1), (2,2,1,0,1,1,2)}, and go to step 5.

Performing step 5: because i=4>1, let i=i−1=3, go to step 4.

Performing step 4: because κ(3)=φ(3)=2, go to step 5.

Performing step 5: if i=3>1, let i=i−1=2, and go to step 4.

Performing step 4: because κ(2)=φ(2)=1, go to step 5.

Performing step 5: if i=2>1, let i=i−1=1, and go to step 4.

Performing step 4: because κ(1)=1<φ(1)=2, let κ(1)=κ(1)+1=2, and go to step 1.

Now the computation goes back to the beginning condition that the level number is 1, such that the process can be performed similarly until the last step as the following.

Performing step 5: because i=1, stop the sequential process, and Ω={p₁=(2,2,2,0,0,1,1),p₂=(2,2,1,0,1,1,2),p₃=(1,2,2,1,0,2,1),p₄=(1,1,1,0,0,2,2)} is a complete solution set of d-MP.

Table 1 presented below is the obtained complete solution set after the whole sequential process, wherein those underlined refer to variables newly obtained. In addition, those with a superscript M mean M^{#}(X)<d, that is, the ones smaller than the maximal capacity, and those with a superscript c mean that the MFN is a loop, and those with a superscript * mean the real d-MP.

TABLE 1

| i | φ (i) | κ(i) | F_{i,κ(i)} | Ωᵢ₊₁ |
|---|---|---|---|---|
| 0 | | 0 | | {(x₁, x₆) [symbol] , (2, 1), (1, 2)} |
| 1 | 2 | 1 | (x₁, x₆) = (2, 1) | {(x₁, x₂, x₄, x₆) = (2, 2, 0, 1)} |
| 2 | 1 | 1 | (x₁, x₂, x₄, x₆) = (2, 2, 0, 1) | {(x₁, x₂, x₃, x₄, x₅, x₆) = (2, 2, 2, 0, 0, 1), (2, 2, 1, |
| | | | | 0, 1, 1), [symbol] } |
| 3 | 2 | 1 | (x₁, x₂, x₃, x₄, x₅, x₆) = (2, 2, 2, 0, 0, 1) | {(x₁, x₂, x₃, x₄, x₅, x₆, x₇) = (2, 2, 2, 0, 0, 1, 1)*} |
| 3 | 2 | 2 | (x₁, x₂, x₃, x₄, x₅, x₆) = (2, 2, 1, 0, 1, 1) | {(x₁, x₂, x₃, x₄, x₅, x₆, x₇) = (2, 2, 1, 0, 1, 1, 2)*} |
| 1 | 2 | 2 | (x₁, x₆) = (1, 2) | {(x₁, x₂, x₄, x₆) = (1, 2, 1, 2), (1, 1, 0, 2)} |
| 2 | 2 | 1 | (x₁, x₂, x₄, x₆) = (1, 2, 1, 2) | {(x₁, x₂, x₃, x₄, x₅, x₆) = (1, 2, 2, 1, 0, 2), [symbol] |
| | | | | [symbol] } |
| 3 | 1 | 1 | (x₁, x₂, x₃, x₄, x₅, x₆) = (1, 2, 2, 1, 0, 2) | {(x₁, x₂, x₃, x₄, x₅, x₆, x₇) = (1, 2, 2, 1, 0, 2, 1)*} |
| 2 | 2 | 2 | (x₁, x₂, x₄, x₆) = (1, 1, 0, 2) | {(x₁, x₂, x₃, x₄, x₅, x₆) = (1, 1, 1, 0, 0, 2), [symbol] |
| | | | | [symbol] } |
| 3 | 1 | 1 | (x₁, x₂, x₃, x₄, x₅, x₆) = (1, 1, 1, 0, 0, 2) | {(x₁, x₂, x₃, x₄, x₅, x₆, x₇) = (1, 1, 1, 0, 0, 2, 2)*} |

Next, given the above description, the complete solution set with 3-MP can be obtained. The reliability of 3-MP (R_{3-MP}) is calculated based on the probability of each arc provided in Table 2. The complete solution set comprises {p₁=(2,2,2,0,0,1,1), p₂=(2,2,1,0,1,1,2),p₃=(1,2,2,1,0,2,1),p₄=(1,1,1,0,0,2,2)}.

TABLE 2

| | Arc | | | | | | |
|---|---|---|---|---|---|---|---|
| Probability | e₁ | e₂ | e₃ | e₄ | e₅ | e₆ | e₇ |
| 4 | 0.65 | | 0.60 | | | | |
| 3 | 0.15 | | 0.15 | | | | |
| 2 | 0.10 | 0.90 | 0.10 | 0.80 | 0.85 | 0.85 | 0.80 |
| 1 | 0.05 | 0.05 | 0.10 | 0.10 | 0.10 | 0.10 | 0.15 |
| 0 | 0.05 | 0.05 | 0.05 | 0.10 | 0.05 | 0.05 | 0.05 |

Next, the calculation can be performed by the inclusion-exclusion method, and the equation is as the following:

$$\begin{matrix}{P}_{3 - MP} = Pr ( {p}_{1} ⋃ {p}_{2} ⋃ {p}_{3} ⋃ {p}_{4} ) \\ = [ Pr ( {p}_{1} ) + Pr ( {p}_{2} ) + Pr ( {p}_{3} ) + Pr ( {p}_{4} ) ] - \\ [ Pr ( {p}_{1 , 2} ) + Pr ( {p}_{1 , 3} ) + Pr ( {p}_{1 , 4} ) + Pr ( {p}_{2 , 3} ) + Pr ( {p}_{2 , 4} ) + Pr ( {p}_{3 , 4} ) ] + \\ [ Pr ( {p}_{1 , 2 , 3} ) + Pr ( {p}_{1 , 2 , 4} ) + Pr ( {p}_{1 , 3 , 4} ) + Pr ( {p}_{2 , 3 , 4} ) ] - Pr ( {p}_{1 , 2 , 3 , 4} ) \\ = 0.746751438\end{matrix}$$

Given above calculation, Table 3 shows the relevant vectors and probability.

TABLE 3

| i | X | Pr(x₁) | Pr(x₂) | Pr(x₃) | Pr(x₄) | Pr(x₅) | Pr(x₆) | Pr(x₇) | Pr(X) |
|---|---|---|---|---|---|---|---|---|---|
| 1 | p₁ = (2, 2, 2, 0, 0, 1, 1) | 0.9 | 0.9 | 0.85 | 1 | 1 | 0.95 | 0.95 | 0.6214 |
| 2 | p₂ = (2, 2, 1, 0, 1, 1, 2) | 0.9 | 0.9 | 0.95 | 1 | 0.95 | 0.95 | 0.8 | 0.5556 |
| 3 | p₃ = (1, 2, 2, 1, 0, 2, 1) | 0.95 | 0.9 | 0.85 | 0.9 | 1 | 0.85 | 0.95 | 0.5282 |
| 4 | p₄ = (1, 1, 1, 0, 0, 2, 2) | 0.95 | 0.95 | 0.95 | 1 | 1 | 0.85 | 0.8 | 0.5830 |
| 5 | p_{1,2} = (2, 2, 2, 0, 1, 1, 2) | 0.9 | 0.9 | 0.85 | 1 | 0.95 | 0.95 | 0.8 | 0.4971 |
| 6 | p_{1,3} = (2, 2, 2, 1, 0, 2, 1) | 0.9 | 0.9 | 0.85 | 0.9 | 1 | 0.85 | 0.95 | 0.5004 |
| 7 | p_{1,4} = (2, 2, 2, 0, 0, 2, 2) | 0.9 | 0.9 | 0.85 | 1 | 1 | 0.85 | 0.8 | 0.4682 |
| 8 | p_{2,3} = (2, 2, 2, 1, 1, 2, 2) | 0.9 | 0.9 | 0.85 | 0.9 | 0.95 | 0.85 | 0.8 | 0.4003 |
| 9 | p_{2,4} = (2, 2, 1, 0, 1, 2, 2) | 0.9 | 0.9 | 0.95 | 1 | 0.95 | 0.85 | 0.8 | 0.4971 |
| 10 | p_{3,4} = (1, 2, 2, 1, 0, 2, 2) | 0.95 | 0.9 | 0.85 | 0.9 | 1 | 0.85 | 0.8 | 0.4448 |
| 11 | p_{1,2,3} = (2, 2, 2, 1, 1, 2, 2) | 0.9 | 0.9 | 0.85 | 0.9 | 0.95 | 0.85 | 0.8 | 0.4003 |
| 12 | p_{1,2,4} = (2, 2, 2, 0, 1, 2, 2) | 0.9 | 0.9 | 0.85 | 1 | 0.95 | 0.85 | 0.8 | 0.4448 |
| 13 | p_{1,3,4} = (2, 2, 2, 1, 0, 2, 2) | 0.9 | 0.9 | 0.85 | 0.9 | 1 | 0.85 | 0.8 | 0.4214 |
| 14 | p_{2,3,4} = (2, 2, 2, 1, 1, 2, 2) | 0.9 | 0.9 | 0.85 | 0.9 | 0.95 | 0.85 | 0.8 | 0.4003 |
| 15 | p_{1,2,3,4} = (2, 2, 2, 1, 1, 2, 2) | 0.9 | 0.9 | 0.85 | 0.9 | 0.95 | 0.85 | 0.8 | 0.4003 |

From the foregoing, the present invention provides a node-based sequential implicit enumeration method and system. Since the conventional implicit enumeration method (IEM) being employed to find all d-MP is troublesome and time-consuming, the sequential implicit enumeration method provided in the present invention reduces the defect of low efficiency, caused by that the conventional path-based algorithms have to find all possible d-MPs. Therefore, the present invention provides an easy and efficient method for finding all possible d-MPs in the integer programming model of the multistate flow network.

The above examples are only used to illustrate the principle of the present invention and the effect thereof, and should not be construed as to limit the present invention. The above examples can all be modified and altered by those skilled in the art, without departing from the spirit and scope of the present invention as defined in the following appended claims.

What is claimed is:

1. A node-based sequential implicit enumeration system, comprising:
a presetting module for setting a multistate flow network including N nodes and required flow;
a building module for building an integer programming model of the multistate flow network, so as to set a complete solution set of the integer programming model as an empty set and set a level number as 1 in advance; and
a computing module for obtaining a complete solution set of a minimal path satisfying the required flow, the computing module comprising:
a solution set unit that finds solution sets of each node in the integer programming model according to a flow conservation rule and excludes unsuitable ones, so as to find a number of elements in each of the solution sets;
a recurring unit that adds 1 to the level number when the level number is determined being less than N−1, so as to use one of the elements in the solution set to sequentially find a solution set of a next level number and a number of elements in the solution set of the next level number through the solution set unit until the level number is equal to N−1; and
a unifying unit that unifies the complete solution set and the solution set of the level number N−1, so as to generate a new complete solution set;
wherein after the solution set of a level number N−1 is obtained, when the level number is larger than 1, the recurring unit subtracts 1 from the level number to determine whether other elements exist in the solution set of the level number, and if so, repeating procedures of the solution set unit, the recurring unit and the unifying unit to produce another new complete solution set, otherwise 1 is continuously subtracted from the level number until the level number is 1, such that a set of minimal path satisfying the required flow is obtained as a final complete solution set.

2. The node-based sequential implicit enumeration system of claim 1, wherein a flow entering each of the nodes of the integer programming model is equal to a flow exiting therefrom, and a flow between two adjacent nodes is not larger than a maximal capacity of an arc formed by the two adjacent nodes.

3. The node-based sequential implicit enumeration system of claim 1, wherein the solution set unit excludes a solution causing a flow between a current node and a next node being larger than a maximal capacity between the current node and the next node from the solution sets of each of the nodes.

4. The node-based sequential implicit enumeration system of claim 1, wherein the solution set unit excludes one consisting of nodes forming a loop and having a nonzero flow in the integer programming model from each of the solution sets.

5. The node-based sequential implicit enumeration system of claim 1, wherein the recurring unit sets a count with an initial value 1 when the number of elements of the solution set is found, so as to determine that the solution set has other elements when the number of elements of the solution set is larger than the count, and 1 is added to the count until the number of elements of the solution set is equal to the count, which means there is no other element in the solution set.

6. A node-based sequential implicit enumeration method, comprising the steps of:
(a) setting a multistate flow network including N nodes and required flow;
(b) building an integer programming model of the multistate flow network, so as to set a complete solution set of the integer programming model as an empty set and set a level number as 1 in advance;
(c) finding solution sets of the level number 1 in the integer programming model according to a flow conservation rule and excluding unsuitable ones, so as to find a number of elements in the solution set, adding 1 to the level number when the level number is determined being less than N−1, so as to use one of the elements in the solution set to sequentially find a solution set of a next level number and a number of elements in the solution set of the next level number until the level number is equal to N−1;
(d) unifying the complete solution set and the solution set of level number N−1, so as to generate a new complete solution set; and
(e) subtracting 1 from the level number to determine whether other elements exist in the solution set of the level number when the level number is larger than 1, and if so, repeating steps (c) and (d) to produce another new complete solution set, otherwise 1 is continuously subtracted from the level number until the level number is 1, such that a final complete solution set thus-obtained is a set of minimal path satisfying the required flow.

7. The node-based sequential implicit enumeration method of claim 6, wherein a flow entering each of the nodes of the integer programming model is equal to a flow exiting therefrom, and a flow between two adjacent nodes is not larger than a maximal capacity of an arc formed by the two adjacent nodes.

8. The node-based sequential implicit enumeration method of claim 6, wherein the elements of each of the solution sets does not include a solution of each of the nodes in the integer programming model causing a flow between a current node and a next node being larger than a maximal capacity between the current node and the next node.

9. The node-based sequential implicit enumeration method of claim 6, wherein the element of each of the solution set does not include nodes forming a loop and having nonzero flow in the integer programming model.

10. The node-based sequential implicit enumeration method of claim 6, wherein the step of determining whether other elements exist in the solution set of the level number further comprises: setting a count with an initial value 1 when the number of elements of the solution set is found, so as to determine that the solution set has other elements when the number of elements of the solution set is larger than the count.
